(19) United States
(12) Patent Application Publication
(10) Pub. No.: US 2022/0074609 A1
(43) Pub. Date: Mar. 10, 2022

(54) BOX-TYPE DUST-FREE WORKSHOP

(71) Applicant: Health Pro Supplies Limited, Kwun Tong (HK)

(72) Inventor: Shum Hin LUNG, Kwun Tong (HK)

(21) Appl. No.: 17/014,656

(22) Filed: Sep. 8, 2020

(51) Int. Cl. F24F 3/16; B08B 17/02; B08B 5/02; B08B 7/00; B08B 3/04

(52) U.S. Cl. CPC F24F 3/161; B08B 17/02; F24F 2003/1667; B08B 7/0035; B08B 3/04; B08B 5/02

(57) ABSTRACT

A box-type dust-free workshop includes a box body, an exit-entrance arranged on the box body, and a purification system, a ventilation system and an electrical system arranged in the box body. The box body may be formed by arranging a plurality of box-type units, and the box-type units are communicated with one another internally; or the interior of the box body may also be divided into a plurality of areas through partition plates. The box-type dust-free workshop can be put into use by arranging related facilities in the box body, does not need to construct a building, and has mobility.

### FIELD OF THE INVENTION

The present invention relates to a box-type dust-free workshop.

### BACKGROUND OF THE INVENTION

Most of the existing workshops (including workplaces, plants, laboratories and etc.) are arranged in a covered building, and due to transporting constraints, relevant components need to be disassembled for transporting and reassembled after arriving at a destination. However, the construction method will encounter various problems in various procedures and subsequent detection and certification, resulting in high construction cost, long construction time and high construction difficulty. Moreover, a built factory building has no mobility and must be reassembled and disassembled when it needs to be relocated. In addition, related construction procedures have high requirement on the proficiency degree of assembling personnel, so it is difficult to construct a large number of workshops in a short time; and the difficulty will be higher if a manufacturer intends to export.

### SUMMARY OF THE INVENTION

According to one aspect of the present invention, provided is a box-type dust-free workshop, which includes a box body, an exit-entrance arranged on the box body, and a purification system, a ventilation system and an electrical system arranged in the box body. The box-type dust-free workshop can be put into use by arranging related facilities in the box body, does not need to construct a building, and has mobility.

In some implementation modes, the box body is formed by arranging a plurality of box-type units; and the box-type units are communicated with one another internally. The size and the combination mode of the box body can be flexibly adjusted according to actual use requirements.

In some implementation modes, the interior of the box body is divided into a plurality of areas through partition plates. The plurality of areas can be used for performing different work at the same without interference.

In some implementation modes, the box body consists of six box-type units, wherein five box-type units are arranged in a line in the width direction of the box-type units; the side walls in the length direction of adjacent two box-type units are in contact and are provided with accesses; the side wall in the length direction of the other box-type unit is in contact with the side walls in the width direction of the five box-type units and is provided with at least one access for communicating with the five box-type units.

In some implementation modes, the purification system includes one or more of an air shower, a cargo shower, bactericidal lamps and purification lamps. Dust-free and sterile effects are achieved in the box body.

In some implementation modes, the ventilation system includes air outlets, air return inlets, and a fan. Air exchange in the box body is realized, so that the box body is filled with fresh air.

In some implementation modes, air conditioning systems are further included. The heat and cold inside the box body are adjusted according to actual requirements.

In some implementation modes, windows are arranged on the box body. The windows are used for ventilating and lighting.

In some implementation modes, the box body is a container. The container can be basically mounted in a factory, finished products can be conveniently transported to the site by an automobile for use; and the container can be reused, is convenient to disassemble and assemble, and is stable and firm.

In some implementation modes, the box-type units are containers. The container can be basically mounted in a factory, finished products can be conveniently transported to the site by an automobile for use; and the container can be reused, is convenient to disassemble and assemble, and is stable and firm.

### BRIEF DESCRIPTION OF THE DRAWINGS

FIG. 1 is plane structure diagram of a box-type dust-free workshop of an implementation mode of the present invention;

FIG. 2 is a plane diagram of a purification system of the box-type dust-free workshop as shown in FIG. 1;

FIG. 3 is a plane structure diagram of a box-type dust-free workshop of another implementation mode of the present invention; and

FIG. 4 is a plane diagram of a purification system of the box-type dust-free workshop as shown in FIG. 3.

### DETAILED DESCRIPTION OF THE EMBODIMENTS

The present invention will be further described in detail with reference to the accompanying drawings.

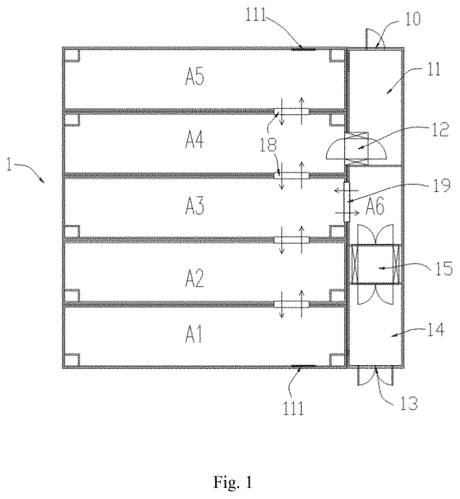

In embodiment 1, FIG. 1 schematically shows a box-type dust-free workshop according to an implementation mode of the present invention. As shown in the figure, the box-type dust-free workshop in the present embodiment is applied to a dust-free plant and includes a box body 1, and a purification system, a ventilation system and an electrical system which are arranged in the box body 1. The box body 1 is formed by arranging six box-type units A1 to A6. The six box-type units A1 to A6 all adopt cuboid containers. The size of each box-type unit is 12.02 m in outer length, 11.92 m in inner length, 2.33 m in outer width, 2.23 m in inner width, 2.68 m in outer height and 2.4 m in inner height, wherein five box-type units A1 to A5 are arranged in a line in the width direction of the box-type units; the side walls in the length direction of adjacent two box-type units are in contact and are provided with accesses 18; the five box-type units A1 to A5 form five workshops communicated with one another; the side wall in the length direction of the other box-type unit A6 is in contact with the side walls in the width direction of the five box-type units A1 to A5; the side wall in the length direction of the box-type unit A6 is provided with an access 19 communicated with the box-type unit A3; the side wall in the width direction of the box-type unit A6 is provided with a personnel exit-entrance 10; there is a dressing room and an air shower 12 after entering the box-type unit A6 from the personnel exit-entrance 10; the air shower 12 is provided with two doors respectively communicated with the dressing room 11 and the box-type unit A4; the other side wall in the width direction of the box-type unit A6 is provided with a cargo inlet-outlet 13; there is an unpacking room 14 and a cargo shower 15 after entering the box-type unit A6 from the cargo inlet-outlet 13; and the cargo shower 15 is provided with two doors respectively communicated with the unpacking room 14 and the box-type unit A3. The box-type units A1 to A6 are fixed by using a fixing frame, and a steel plate is arranged as a periphery.

In the present embodiment, the purification system includes the air shower 12, the cargo shower 15 and purification lamps, wherein the purification lamps are respectively arranged in each of the box-type units A1 to A6, and meanwhile, serve as a lighting system in the corresponding box-type unit; and 3 to 5 purification lamps are arranged in each of the box-type units at intervals.

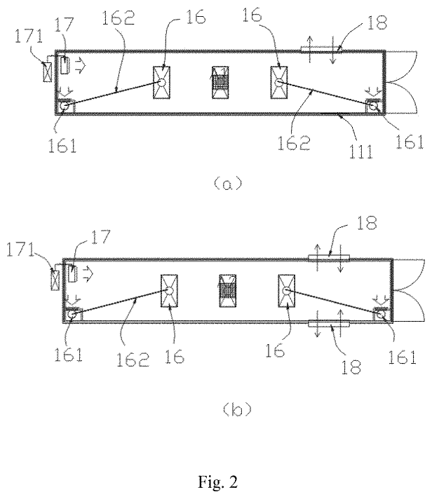

In the present embodiment, as shown in FIG. 2, wherein FIG. 2(a) is a plane structure diagram of the box-type units A1 and A5, and FIG. 2 (b) is a plane structure diagram of the box-type units A2 to A3. The ventilation system adopts a fan filter unit 16; a plurality of fan filter units 16 are respectively arranged in the box-type units A1 to A5; the fan filter units 16 are arranged at the tops of the box-type units A1 to A5; the positions of the air outlets correspond to the fan filter units 16; the air return inlets 161 are formed in the lower parts of two corners of each of the box-type units A1 to A5; and the air return inlets 161 are communicated with air inlets of the fan filter units 16 through air return pipelines 162.

In the present embodiment, the air return pipelines 162 adopt aluminum foil hoses; and air return shutters are arranged at the air return inlets.

In the present embodiment, the box-type units A1 to A5 are also provided with air conditioning systems which adopt heating and cooling cabinet type air conditioners 17, wherein air conditioner external units 171 are arranged outside the box-type units A1 to A5.

In the present embodiment, the box-type units A1 to A6 are respectively provided with independent electrical systems; and each electric system includes a distribution box and a transformer, and provides electrical power for the corresponding box-type unit.

In the present embodiment, water supply pipelines are arranged in the box-type units A1 to A6.

In the present embodiment, escape exits 111 are further arranged on the side walls in the length direction of the non-contact ends of the box-type units A1 and A5 at two ends; and tempered glass is arranged at the escape exits.

In the present embodiment, floors are laid on the ground of each of the box-type units A1 to A6; the floors adopt PVC coiled material floors; and machine-made glass magnesium color steel plate suspended ceilings are arranged at the ceilings of the box-type units A1 to A6.

Facilities to be used are arranged in box-type units (containers) in advance; the overall box-type unit can be used after being transported to a destination and then connected to local water and electricity; and a dust-free workshop that can be moved at any time is not restricted by a construction site and does not need to construct a building, which shortens the construction time and saves manpower, cost and time.

In some other implementation modes, the box-type units may be arranged in a variety of ways and combined using the containers according to the size required by actual application.

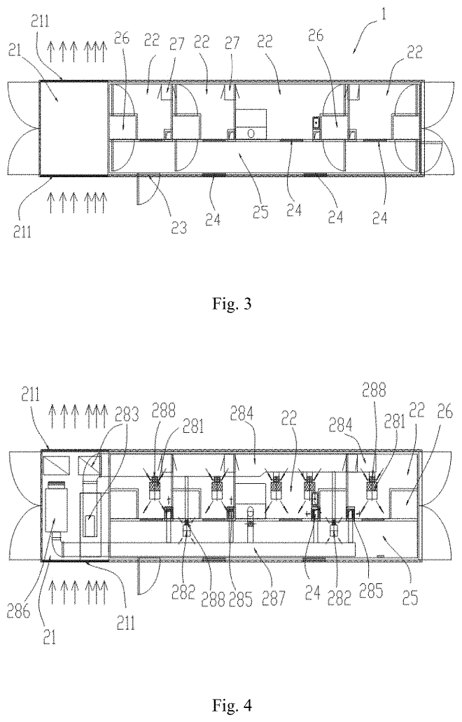

In embodiment 2, FIG. 3 schematically shows a box-type dust-free workshop according to another implementation mode of the present invention. As shown in the figure, the box-type dust-free workshop in the present embodiment is applied to a laboratory and includes a box body 1, and a purification system, a ventilation system and an electrical system arranged in the box body 1. The box body 1 adopted in the present embodiment is a cuboid container, and the size of the container is 12.02 m in outer length, 11.92 m in inner length, 2.33 min outer width, 2.23 m in inner width, 2.68 m in outer height, and 2.4 m in inner height. The interior of the box body 1 is divided into a plurality of areas through partition plates. The plurality of areas include an equipment room area 21 arranged at one end of the box body 1 and a plurality of working sections 22 arranged in the length direction of the box body 1, wherein one side wall of each of the plurality of working sections 22 is in contact with one side wall of the box body 1; an exit-entrance 23 and a plurality of windows 24 are arranged on the other side wall of the box body 1; a corridor 25 is arranged outside the plurality of working sections 22; each of the working sections 22 is provided with an access; a buffer room 26 is arranged at the access; a worker enters and exits the working sections 22 through the buffer room 26; the windows 24 are arranged on the side walls, facing the corridor 25, of the plurality of working sections; and a transferring window 27 is arranged between adjacent two working sections.

In the present embodiment, the purification system includes germicidal lamps and purification lamps, wherein a purification lamp and a germicidal lamp are arranged in each working section 22; a purification lamp is arranged in each buffer room 26; and a plurality of purification lamps are arranged on the corridor 25.

In the present embodiment, as shown in FIG. 4, the ventilation system adopts a pipeline ventilation circulating system which includes first air outlets 281 arranged in each working section 22, second air outlets 282 arranged in the corridor 25, an air conditioning unit 283, an air outlet pipeline 284 for communicating the air conditioning unit 283 with the first air outlets 281 and the second air outlets 282, air return inlets 285 arranged in each working section 22, an exhaust cabinet (fan) 286, and an exhaust pipeline 287 for communicating the exhaust cabinet (fan) 286 with the air return inlets 285; the air conditioning unit 283 and the exhaust cabinet (fan) 286 are arranged in the equipment room area 21 at one end of the box body 1; 1 to 2 first air outlets 281 and air return inlets 285 are arranged in each working section 22; and 2 to 3 second air outlets 282 are arranged on the corridor 25.

In the present embodiment, an air valve 288 for controlling the air volume of corresponding air outlet is arranged at each of the first air outlets 281 and the second air outlets 282; the air outlet pipeline 284 is a galvanized air pipe; and the exhaust pipeline 287 is a PVC exhaust pipe.

In the present embodiment, waterproof shutters 211 used for the ventilation of equipment are arranged on both side walls of the equipment room area 21.

In the present embodiment, floors are laid on the ground of the box body 1; the floors adopt PVC coiled material floors; and a machine-made glass magnesium color steel plate suspended ceiling is arranged at the ceiling of the box body 1.

A working section of a laboratory is arranged in a container, so that the laboratory can be used more quickly, the construction time is shortened, the laboratory is not limited by site, the laboratory has mobility and can be carried to different places by a vehicle for performing sampling, detecting and experiment; and the efficiency is higher.

In some other implementation modes, a plurality of box bodies 1 may be arranged and combined by using containers according to the size required by actual application.

According to the present invention, the box-type dust-free workshop is combined and constructed by using the containers and can be applied to various occasions; the value-added utilization of the containers is realized; and the containers are very firm and can bear high pressure. The workshop can be mounted in a factory, and finished products are transported to the site by an automobile for splicing or direct use, and can also be directly hoisted during transportation, so that the workshop is very convenient. The containers can be reused, and are convenient to disassemble and assemble, excellent in performance, stable and firm, good in shockproof performance and relatively low in cost.

The above are only some implementation modes of the present invention. A number of variations and modifications may also be made by those of ordinary skill in the art without departing from the conception of the present invention, and all fall within the scope of protection of the present Invention.

1. A box-type dust-free workshop, comprising: a box body, an exit-entrance arranged on the box body, and a purification system, a ventilation system and electrical systems arranged in the box body.

2. The box-type dust-free workshop according to claim 1, wherein the box body is formed by arranging a plurality of box-type units, and the box-type units are communicated with one another internally.

3. The box-type dust-free workshop according to claim 1, wherein the interior of the box body is divided into a plurality of areas through partition plates.

4. The box-type dust-free workshop according to claim 2, wherein the box body consists of six box-type units, five box-type units are arranged in a line in the width direction of the box-type units; the side walls in the length direction of adjacent two box-type units are in contact and are provided with accesses; and the side wall in the length direction of the other box-type unit is in contact with the side walls in the width direction of the five box-type units and is provided with at least one access for communicating with the five box-type units.

5. The box-type dust-free workshop according to claim 1, wherein the purification system comprises one or more of an air shower, a cargo shower, bactericidal lamps and purification lamps.

6. The box-type dust-free workshop according to claim 1, wherein the ventilation system comprises air outlets, air return inlets and a fan.

7. The box-type dust-free workshop according to claim 1, further comprising air conditioning systems.

8. The box-type dust-free workshop according to claim 1, wherein windows are arranged on the box body.

9. The box-type dust-free workshop according to claim 1, wherein the box body is a container.

10. The box-type dust-free workshop according to claim 2, wherein the box-type units are containers.
